(19) United States
(12) Patent Application Publication
(10) Pub. No.: US 2026/0202236 A1
(43) Pub. Date: Jul. 16, 2026

(54) METHOD FOR LEVEL CORRECTION OF A LOAD CELL IN A WEIGHING SYSTEM

(71) Applicants: Mettler-Toledo (Changzhou) Precision Instruments Ltd., Changzhou (CN); Mettler-Toledo (Changzhou) Measurement Technology Ltd., Changzhou (CN); Mettler-Toledo Technologies (China) Co., Ltd, Shanghai (CN)

(72) Inventors: Shenhui Wang, Changzhou (CN); Jun Gu, Changzhou (CN); Li Yang, Changzhou (CN); Jianwei Wu, Changzhou (CN); Jianqiang Yang, Changzhou (CN); Yupeng Zhao, Changzhou (CN); Jinjie Cai, Changzhou (CN); Zheng Guo, Changzhou (CN); Chunhui Li, Changzhou (CN); Song Zhang, Changzhou (CN)

(21) Appl. No.: 19/119,815

(22) PCT Filed: Oct. 20, 2023
(86) PCT No.: PCT/CN2023/125749

§ 371 Date: Apr. 10, 2025

(30) Foreign Application Priority Data
Oct. 21, 2022 (CN) 202211293686.9

(51) Int. Cl. G01G 23/00; G01M 1/12

(52) U.S. Cl. CPC G01G 23/002; G01M 1/122

(57) ABSTRACT

Methods for correcting the level of a load cell in a weighing system are disclosed. An actual load value from N load cells of the weighting system is obtained and summed. Center of mass of the object to be weighed is calculated in an X and Y direction based on position coordinates of the N load cells. A load cell of the N load cells is selected and an ideal load value of the (N−1) load cells is expressed in terms of an ideal load value of the selected load cell. The ideal load value of each load cell is calculated based on a proportional relationship of the summation of the ideal load values of the N load cells and the summation of actual load value. The proportional relationship is based on a principle that the center of mass of the object to be weighed on a horizontal plane is constant. A load difference is calculated between the ideal load value and the actual load value of each load cell. The least load difference Δwi of N load cells is calculated and an instruction for correcting the level of the load cells is output.

### BACKGROUND OF THE INVENTION

### Technical Field

The present invention relates to the field of weighing systems, and in particular, to the methods for level correction of load cells in a weighing system.

### Background Art

A weighing system comprising at least three load cells or weighing modules, where the amount of force exerted on each of these load cells or weighing modules might vary, that is, the load cells or the weighing modules are not in an evenly levelled state. As a result, there might be a difference between an actual force exerted on a load cell than an ideal force that has to be exerted on the load cell or weighing module, which in turn affects the performance of the weighing system.

For the foregoing problem, a gasket is usually inserted or removed from the load cell to change a height of the load cell or weighing module. In this way, a load carried by the load cell or weighing module under less force is increased, and an excess force exerted on another load cell or weighing module is reduced. In this way, the load cell or weighing module is maintained in an evenly levelled state, to ensure the accuracy of the weighing system.

Currently, there are two methods for correcting the level of the load cell or weighing module. According to a first method, the level of the load cell or weighing module is manually corrected by a skilled personnel based on an output of the load cell or weighing module. According to a second method, the level of the load cell or weighing module is corrected based on the output of the load cell or weighing module and ideal characteristic data of the weighing system.

In both the above-mentioned methods, when a structure of the weighing system is simple or a when there only a few load cells or weighing modules, the level correction of the load cell or weighing module can be performed in less time and in a less laborious manner. However, when the structure of the weighing system is complex, particularly in a situation of complex field devices, it is more complicated and difficult to obtain the ideal characteristic data of the weighing system and correct the level of the load cell or the weighing module.

### SUMMARY

An objective of the present invention is to provide a method for level correction of a load cell in a weighing system which is more convenient and less time consuming.

To achieve the foregoing objective, the method for correcting a level of load cell in a weighing system for weighing an object, includes steps of:
obtaining an actual load value wi from N load cells and performing a summation of the actual load values obtained from the N load cells;
calculating centre of mass Cₓ and C_{y} of the object in an X direction and a in Y direction based on position coordinates xᵢ and yᵢ respectively of the N load cells;
selecting an i^{th} load cell having an ideal load value of Wt₁ from the N load cells and expressing the ideal load value Wtᵢ of the (N−1) load cells in terms of the ideal load value Wt₁;
calculating the ideal load value Wtᵢ of each load cell according to a proportional relationship of a summation of the ideal load values

$${\sum }_{i = 1}^{N} {Wt}_{i}$$

of the N load cells to the summation of the actual load values

$${\sum }_{i =}^{N} {w}_{i}$$

of the N load cells, wherein the proportional relationship is based on a principle that the centre of mass of the object when placed on a horizontal plane is constant; and
calculating a load difference Δwi between the ideal load value Wtᵢ and the actual load value wᵢ of each of the N load cells, and if determining the load difference Δwᵢ of each of the N load cells and output an instruction for correcting the level of the load cells.

The ideal load value refers to a load value of a load exerted on the weighing modules when the weighing system is in an ideal status, i.e., the weighing system is manufactured and assembled exactly as per the design specifications, and then the assembled system is calibrated and tested for compliance.

In one or more embodiments, the centre of mass of the object in the X direction and the Y direction is computed by

$${C}_{x} = \frac{\sum {w}_{i} \cdot x}{\sum {w}_{i}} and {C}_{y} = \frac{\sum {w}_{j} \cdot {y}_{i}}{\sum {w}_{i}} ,$$

where Cₓ indicates the centre of mass of the object in the X direction, C_{y} indicates the centre of mass of the object in the Y direction, wᵢ indicates an actual load value of a load cell, xᵢ indicates a position coordinate of the load cell in the X direction, yᵢ indicates a position coordinate of the load cell in the Y direction, and i indicates the i^{th} load cell.

In one or more embodiments, the centre of mass of the object in the X direction and the Y direction by using the ideal load value Wtᵢ of the load cell is computed by

$${C}_{x} = \frac{\sum {Wt}_{i} \cdot {x}_{i}}{\sum {Wt}_{i}} and {C}_{y} = \frac{\sum {Wt}_{i} \cdot {y}_{i}}{\sum {Wt}_{i}} ,$$

where Cₓ indicates the centre of mass of the object in the X direction, C_{y} indicates the centre of mass of the object in the Y direction, Wtᵢ indicates an ideal load value of a load cell, xᵢ indicates a position coordinate of the load cell in the X direction, yᵢ indicates a position coordinate of the load cell in the Y direction, and i indicates the i^{th} load cell.

In one or more embodiments, the proportional relationship between the summation of the ideal load values

$${\sum }_{i = 1}^{N} {Wt}_{i}$$

and the summation of the actual load values

$${\sum }_{i = 1}^{N} {w}_{i}$$

is denoted as Σwᵢ=ΣWtᵢ, where Wtᵢ indicates an ideal load value of each of the N load cells, wᵢ indicates an actual load value of each of the N load cells, and i indicates an i^{th} load cell.

In one or more embodiments, the ideal load value Wtᵢ is expressed based on the ideal load value Wt₁ of the selected load cell as Wtᵢ=Wt₁+Kₓ(xᵢ−x₁)+K_{y}(yᵢ−y₁), where Kₓ indicates an inclination coefficient of a load cell plane in the X direction, K_{y} indicates an inclination coefficient of the load cell plane in the Y direction, xᵢ indicates a position coordinate of a load cell in the X direction, y; indicates a position coordinate of the load cell in the Y direction, i indicates an ith load cell, Wt₁ indicates an ideal load value of an i^{th} load cell selected from the N load cells, and Wtᵢ indicates the ideal load value of the (N−1) load cells.

In one or more embodiments, the ideal load value Wtᵢ of the N load cells is calculated based on the proportional relationship and the principle that the centre of mass of the object on a horizontal plane is constant. Here, the inclination coefficient Kx in the X direction, the inclination coefficient Ky in the Y direction, and the ideal load value Wt₁ of the selected load cell of the N load cells are first calculated, and the step is repeated for calculating the ideal load value Wtᵢ of all the (N−1) load cells based on the inclination coefficient Kx in the X direction, the inclination coefficient Ky in the Y direction, and the ideal load value Wt₁ of the selected ith load cell of the N load cells.

In one or more embodiments, the inclination coefficient Kx in the X direction, the inclination coefficient Ky in the Y direction, and the ideal load value Wt1 of the selected load cell are obtained by solving the following set of equations:

$$\{ \begin{matrix}\sum {w}_{i} = {\sum }_{i = 1}^{N} {Wt}_{i} \\ {C}_{x} = \frac{{\sum }_{i = 1}^{N} {Wt}_{i} \cdot {x}_{i}}{{\sum }_{i = 1}^{N} {Wt}_{i}} \\ {C}_{y} = \frac{{\sum }_{i = 1}^{N} {Wt}_{i} \cdot {y}_{i}}{{\sum }_{i = 1}^{N} {Wt}_{i}} \\ {Wt}_{i} = {Wt}_{1} + {K}_{x} ( {x}_{n} - {x}_{1} ) + {K}_{y} ( {y}_{n} - {y}_{1} )\end{matrix}$$

In one or more embodiments, the load difference between the ideal load value and the actual load value of each load cell is calculated by Δwᵢ=Wtᵢ−wᵢ, where Δwi indicates the load difference of each of the N load cells, Wti indicates an ideal load value of each load cell, wi indicates an actual load value of each load cell, and i indicates an ith load cell.

In one or more embodiments, a gasket is installed for a load cell where the load difference value has a least negative value.

Preferably, the gasket is installed either between the weighing module and the object to be weighed, or between the load cell and upper plate of the weighing module. In most cases, a lifting jack can be used to lift the object to be weighed, and then the gasket is installed in a desired position. These positions are exemplary and the gasket can be installed in other position based on the requirements and as per the convenience.

In one or more embodiments, the N load cells of the weighing system represents at least three load cells.

According to the level correction method for a weighing system, the principle that the centre of mass of the object in a horizontal plane is constant is used, the ideal load value of each load carrying sensor is directly calculated based on load cell data obtained from the weighing module on site and a set of theoretical formula, and the load difference between the ideal load value and the actual load of each load cell which is used as the instruction data for adjustment of the weighing system. In this way, a level correction process is simplified, a evenly levelled status of the load cell or weighing module is conveniently and quickly achieved, and performance of the weighing system is improved.

The features, properties, and advantages of the present invention will become clearer through the following description with reference to the accompanying drawing and embodiments, in which:

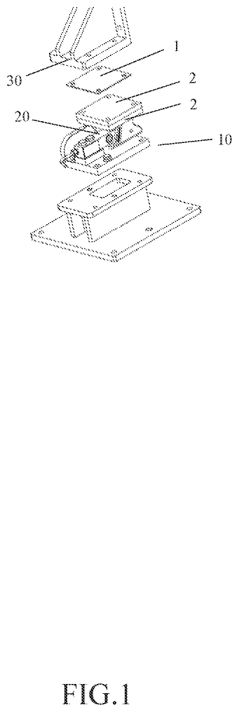

FIG. 1 is a partial exploded view of the weighing system, which shows the installation position of the gasket in one embodiment.

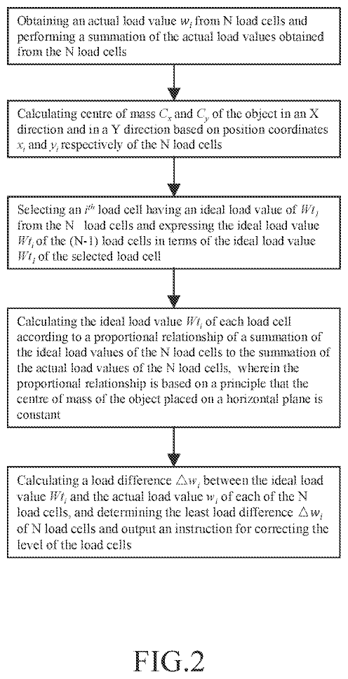

FIG. 2 is a flowchart of an embodiment of a method of level correction for a weighing system.

### BRIEF DESCRIPTION OF THE DRAWINGS

The present invention will be further described below with reference to specific embodiments and accompanying drawings. In the following description, more details are illustrated to facilitate a full understanding of the present invention, but it will be understood that the present invention can be implemented in a variety of ways different from this description, and those skilled in the art can make similar extensions and interpretations based on practical applications without departing from the scope of the present invention. Therefore, the scope of protection of the present invention should not be limited by the content of the specific embodiments.

It should be noted that the drawings are merely examples and not drawn to scale, and should not be construed as limiting the scope of protection actually claimed by the present invention.

A weighing system of the invention is configured to weigh an object that is heavy such as a bucket or an electric appliance. The weighing system comprises of N load cells, and the load cells are required to be in a evenly levelled state, to ensure accuracy of weighing the object. However, it is currently inconvenient to adjust a level of the load cell or weighing module. According to a method of level correction for a weighing system in the present disclosure, the above correction process can be simplified, and the levelled status of the load cell or weighing module can be conveniently and quickly ensured.

As shown in FIG. 1, the weighing module 10 comprises a load cell 20 and an upper plate 1 located above the load cell 20. The top surface of the upper plate 1 is in contact with the bottom of the object to be weighed 30, when the object is loaded onto the load cell 20 of the weighing module 10 for weighing. In this embodiment, gaskets 2 can be placed on the top surface of the load cell 20 and between the load cell 20 and the upper plate 1 to evenly level the weighing module 10. The number of gaskets 2 can be increased or decreased according to the required height. In this embodiment, two gaskets are used as an example, but one or more gaskets can be used by those skilled in the art. In other embodiments, gaskets 2 can also be placed in other suitable locations, such as between the upper plate 1 and the object to be weighed 30.

As shown in FIG. 2, the method for correcting the level of one or more load cells in a weighing system, includes the following steps. It should be noted that step arrows in the accompanying drawing merely describe an example process of an embodiment, and do not necessarily form sequential logic of the method.

First, obtaining an actual load value w; from N load cells and performing a summation of the actual load values

$${\sum }_{i = 1}^{N} {w}_{i}$$

obtained from the N load cells, then calculating centre of mass Cₓ and C_{y} of the object in an X direction and a Y direction based on position coordinates xi and yi of the N load cells respectively. The X direction is orthogonal to the Y direction. For example, the actual load values wi of the N load cells and the corresponding position coordinates xi in the X direction and yi in the Y direction on a horizontal plane are separately obtained, and a weighing load value and the centre of mass of the object are calculated based on the foregoing actual load value of each load cell.

Specifically, the centre of mass of the object is computed by

$${C}_{x} = \frac{\sum {w}_{i} \cdot {x}_{i}}{\sum {w}_{i}} and {C}_{y} = \frac{\sum {w}_{i} \cdot {y}_{i}}{\sum {w}_{i}} ,$$

where Cx indicates the centre of mass of the object in the X direction, Cy indicates the centre of mass of the object in the Y direction, wi indicates an actual load value of a load cell, xi indicates a position coordinate of the load cell in the X direction, yi indicates a position coordinate of the load cell in the Y direction, and i indicates the ith load cell.

In some embodiments, the weighing system includes at least three load cells. A value of N is greater than or equal to 3.

After calculating the centre of mass Cx and Cy using the actual load value wᵢ, an ith load cell with actual load value Why is selected load cell. Then, the ideal load value Wtᵢ of the (N−1) load cells is expressed in terms of an ideal load value Wt₁ of the selected load cell. This step is based on the principle of the mathematical and mechanical model of the weighing system. The load cell or weighing module measures force based on the deformation, so that the force exerted may be considered as an elastic force. The weighing system is in an ideal state, therefore the deformation of each load cell is coplanar. The ideal load value Wtᵢ of the (N−1) load cells is expressed in terms of the inclination coefficients Kx and Ky of a plane, and the ideal load value Wt1 of the selected load cell, as Wtᵢ=Wt₁+Kₓ(xᵢ−x₁)+K_{y}(yᵢ−y₁).

For example, if the actual load value of the selected ith load is Wt₁, then an ideal load value of a second load cell of the (N−1) load cells denoted as Wt₂ is expressed in terms of Wt₁ as Wt₂=Wt₁+Kₓ(x₂−x₁)+K_{y}(y₂−y₁).

In a similar way, the ideal load value of a third load cell of the (N−2) load cells denoted as Wt₃ is expressed in terms of Wt₁ as Wt₃=Wt₁+Kₓ(x₃−x₁)+K_{y}(y₃−y₁). It is to be understood that an ideal load value of the ith load cell in terms of Wt₁ is Wtᵢ=Wt₁+Kₓ(xᵢ−x₁)+K_{y}(yᵢ−y₁), where Wt1, Kx, and Ky are all unknowns.

It should be noted that wi is an actually measured load on the load cell, and Wti is the ideal load value of the ideal characteristic data of the load cell calculated based on positions of the measured centre of mass of an object.

After the ideal load value of each load cell is obtained, a next step is performed where the ideal load values of each load cell is calculated based on a principle that a summation of the ideal load values of the N load cells is equal to the summation of the actual load value, and a principle that the centre of mass of the object on a horizontal plane is constant.

When a level of the load cell or weighing module is corrected, only a distribution of weighing force exerted on the load cells or weighing modules is usually corrected, and the weighing force is kept as a constant. Therefore, considering an ideal load value, the relationship of the summation of the ideal load value

$${\sum }_{i = 1}^{N} {Wt}_{i}$$

and the summation of the actual load value

$${\sum }_{i = 1}^{N} {w}_{i}$$

is expressed as Σwᵢ=ΣWtᵢ.

In addition, the positions of the centre of mass of the object on the horizontal plane is considered as constant, so correcting the level of the load cell or weighing module usually does not affect the position of the centre of mass of the object in the X direction and the Y direction. Based on this principle, the centre of mass of the object in the X direction and the Y direction calculated in terms of the ideal load value Wti of the load cell is equivalent to the centre of mass of the object in the X direction and the Y direction in terms of the actual load value wi of the load cell.

The centre of mass of the object in the X direction and the Y direction in terms of the ideal load value Wti of the load cell is computed by

$${C}_{x} = \frac{\sum {Wt}_{i} \cdot {x}_{i}}{\sum {Wt}_{i}} and {C}_{y} = \frac{\sum {Wt}_{i} \cdot {y}_{i}}{\sum {Wt}_{i}} ,$$

which can be expressed in terms of the actual load value wi and expressed as

$${C}_{x} = \frac{\sum {Wt}_{i} \cdot {x}_{i}}{\sum {Wt}_{i}} = \frac{\sum {w}_{i} \cdot {x}_{i}}{\sum {wt}_{i}} and {C}_{y} = \frac{\sum {Wt}_{i} \cdot {y}_{i}}{\sum {Wt}_{i}} = \frac{\sum {wt}_{i} \cdot {y}_{i}}{\sum {wt}_{i}} .$$

After the foregoing equations are obtained, the ideal load value of each load cell is calculated based on the relationship between the summation of the ideal load values of the N load cells and the summation of the actual load values of the N load cells, and the principle that the centre of mass of the object is constant on a horizontal plane, where the inclination coefficient Kx in the X direction, the inclination coefficient Ky in the Y direction, and the ideal load value Wt1 of the selected load cell are first calculated.

Specifically, the inclination coefficient Kx in the X direction, the inclination coefficient Ky in the Y direction, and the ideal load value Wt1 of the selected load cell are obtained by solving the following equation set:

$$\{ \begin{matrix}\sum {w}_{i} & = {\sum }_{i = 1}^{N} {Wt}_{i} \\ {C}_{x} & = \frac{{\sum }_{i = 1}^{N} {Wt}_{i} \cdot {x}_{i}}{{\sum }_{i = 1}^{N} {Wt}_{i}} \\ {C}_{y} & = \frac{{\sum }_{i = 1}^{N} {Wt}_{i} \cdot {y}_{i}}{{\sum }_{i = 1}^{N} {Wt}_{i}} \\ {Wt}_{i} & = {Wt}_{1} + {K}_{x} ( {x}_{n} - {x}_{1} ) + {K}_{y} ( {y}_{n} - {y}_{1} )\end{matrix}$$

The relational expression Wtᵢ=Wt₁+Kₓ(xᵢ−x₁)+K_{y}(yᵢ−y₁) is substituted into the three equations to obtain a linear equation set of three unknowns, including the foregoing equation set about the inclination coefficient Kx in the X direction, the inclination coefficient Ky in the Y direction, and the ideal load value Wt1 of the selected load cell. For example, if there are three load cells i.e., N=3, the obtained linear equation set of three unknowns is:

$$\{ \begin{matrix}\sum {w}_{i} & = {Wt}_{1} + {Wt}_{2} + {Wt}_{3} \\ {C}_{x} & = \frac{{Wt}_{i} \cdot {x}_{i} + ( {Wt}_{1} + {K}_{x} ( {x}_{2} - {x}_{1} ) + {K}_{y} ( {y}_{2} - {y}_{1} ) {x}_{2} + ( {Wt}_{1} + {K}_{x} ( {x}_{3} - {x}_{1} ) + {K}_{y} ( {y}_{2} - {y}_{1} ) {x}_{3}}{{Wt}_{1} + {Wt}_{2} + {Wt}_{3}} \\ {C}_{y} & = \frac{{Wt}_{i} \cdot {y}_{i} + ( {Wt}_{1} + {K}_{x} ( {x}_{2} - {x}_{1} ) + {K}_{y} ( {y}_{2} - {y}_{1} ) {y}_{2} + ( {Wt}_{1} + {K}_{x} ( {x}_{3} - {x}_{1} ) + {K}_{y} ( {y}_{2} - {y}_{1} ) {y}_{3}}{{Wt}_{1} + {Wt}_{2} + {Wt}_{3}}\end{matrix}$$

After calculating the inclination coefficient Kx in the X direction, the inclination coefficient Ky in the Y direction, and the ideal load value Wt1 of the selected load cell, calculating the ideal load value Wti of the (N−1) load cells, that is, an ideal load of the (N−1) load cells based on the three variables and using Wtᵢ=Wt₁+Kₓ(xᵢ−x₁)+K_{y}(yᵢ−y₁).

It should be noted that Wt1 is the ideal load value of the selected load cell.

After the ideal load value of each load cell is obtained, a load difference between the ideal load value and the input load value of each of the load cell is finally calculated, and the load difference of each load cell is used for assessment to output an instruction for correcting the level of any of the load cell.

In this step, the actual load value is subtracted from the ideal load value to obtain the instruction data for adjusting the level of the load cell. The load difference between the ideal load value and the actual load value of each load cell is Δwᵢ=Wtᵢ−wᵢ, where Δwi indicates the load difference of each load cell.

Correcting the level of the load cell is correcting Δwi which has to be minimum. For example, a gasket is installed for a load cell having a load difference value Δwi in which is a least negative value. In this way, the load difference value Δwi of any of the load cells in the weighing system in a maximum negative Prange is reduced, to finally make the actual input value wi being consistent with the ideal load value Wti.

It should be noted that the least negative value of the load difference is a value that satisfies two conditions that the load difference Δwi is negative and an absolute value of the load difference Δwi is maximum.

Therefore, according to the foregoing method, based on measurement of the positions of the centre of mass, the positions of the centre of mass of the measured object are obtained based on values measured by the load cells, and the ideal state of the load cell/weighing module is created based on information about the positions of the centre of mass of the weighed object and a deformation-based weighing principle of the load cell/weighing module, so that the system is defined by homogeneous equations rather than overdetermined equations to obtain the ideal load of each load cell/weighing module. A difference between an ideal output and a current actual output of each load cell/weighing module is used for instructing to correct the level of the load cell/weighing module without the interference from an experienced personnel, and for a plurality of field devices in a complex situation, the load cell can be conveniently, easily, and quickly corrected under the instructions. This helps reduce labor costs for correction, reduce correction time, and further improve performance of the weighing system.

Specific words are used in the present application to describe the embodiments of the present application. For example, “one embodiment”, “an embodiment”, and/or “some embodiments” mean a certain feature, structure, or characteristic related to at least one embodiment of the present application. Therefore, it should be emphasized and noted that “an embodiment” or “one embodiment” or “an alternative embodiment” mentioned twice or more in different positions in this specification does not necessarily refer to the same embodiment. In addition, certain features, structures, or characteristics in one or more embodiments of the present application can be appropriately combined.

Although the present invention is disclosed as above in preferred embodiments, these preferred embodiments are not intended to limit the present invention. Those skilled in the art can make possible changes and modifications without departing from the spirit and scope of the present invention. Therefore, any amendments, equivalent changes, and modifications made to the above embodiments according to the technical essence of the present invention, without departing from the content of the technical solutions of the present invention, shall fall within the scope of protection defined by the claims of the present invention.

1. A method for level correction of at least a load cell in a weighing system configured to weigh an object, said method comprising steps of:
a. obtaining an actual load value wᵢ from N load cells and performing a summation of the actual load values obtained from the N load cells;
b. calculating center of mass Cₓ and C_{y} of the object in an X direction and in a Y direction based on position coordinates xᵢ and yᵢ respectively of the N load cells;
c. selecting an i^{th} load cell having an ideal load value of Wt₁ from the N load cells and expressing the ideal load value Wtᵢ of the (N−1) load cells in terms of the ideal load value Wt₁ of the selected load cell;
d. calculating the ideal load value Wtᵢ of each load cell according to a proportional relationship of a summation of the ideal load values
$${\sum }_{i = 1}^{N} {Wt}_{i}$$
of the N load cells to the summation of the actual load values
$${\sum }_{i = 1}^{N} {w}_{i}$$
of the N load cells, wherein the proportional relationship is based on a principle that the center of mass of the object placed on a horizontal plane is constant; and
e. calculating a load difference Δwᵢ between the ideal load value Wtᵢ and the actual load value wᵢ of each of the N load cells, and determining the least load difference Δwᵢ of N load cells and output an instruction for correcting the level of the load cells.

2. The method according to claim 1, wherein the center of mass of the object in the X direction and the Y direction is computed by
$${C}_{x} = \frac{\sum {w}_{i} \cdot {x}_{i}}{\sum {w}_{i}} and {C}_{y} = \frac{\sum {w}_{i} \cdot {y}_{i}}{\sum {w}_{i}} ,$$
wherein Cₓ indicates the center of mass of the object in the X direction, C_{y} indicates the center of mass of the object in the Y direction, wᵢ indicates an actual load value of a load cell, xi indicates a position coordinate of the load cell in the X direction, yᵢ indicates a position coordinate of the load cell in the Y direction, and i indicates the ith load cell.

3. The method according to claim 1, wherein the center of mass of the object in the X direction and the Y direction by using the ideal load value Wtᵢ of the load cell is computed by
$${C}_{x} = \frac{\sum {Wt}_{i} \cdot {x}_{i}}{\sum {Wt}_{i}} and {C}_{y} = \frac{\sum {Wt}_{i} \cdot {y}_{i}}{\sum {Wt}_{i}} ,$$
wherein Cₓ indicates the center of mass of the object in the X direction, C_{y} indicates the center of mass of the object in the Y direction, Wtᵢ indicates an ideal load value of a load cell, xᵢ indicates a position coordinate of the load cell in the X direction, yᵢ indicates a position coordinate of the load cell in the Y direction, and i indicates the i^{th} load cell.

4. The method according to claim 1, wherein the proportional relationship between the summation of the ideal load value
$${\sum }_{i = 1}^{N} {Wt}_{i}$$
and the summation of the actual load value
$${\sum }_{i = 1}^{N} {w}_{i}$$
is denoted as Σwᵢ=ΣWtᵢ, wherein Wtᵢ indicates an ideal load value of each of the N load cells, wᵢ indicates an actual load value of each of the of N load cells, and i indicates an i^{th} load cell.

5. The method according to claim 1, wherein the ideal load value Wtᵢ is expressed based on the ideal load value Wt₁ as Wtᵢ=Wt₁+Kₓ(xᵢ−x₁)+K_{y}(yᵢ−y₁), wherein Kₓ indicates an inclination coefficient of a load cell plane in the X direction, K_{y} indicates an inclination coefficient of the load cell plane in the Y direction, xᵢ indicates a position coordinate of a load cell in the X direction, yᵢ indicates a position coordinate of the load cell in the Y direction, i indicates an h load cell, Wt₁ indicates an ideal load value of the selected load cell, and Wtᵢ indicates the ideal load value of the (N−1) load cells.

6. The method according to claim 5, wherein the method of calculating the ideal load value Wtᵢ of each of the (N−1) load cells comprises computing the inclination coefficient Kₓ in the X direction, the inclination coefficient K_{y} in the Y direction, and the ideal load value Wt₁ of the selected load cell, and then repeating the computing step till all the ideal load values Wtᵢ of the (N−1) load cells are calculated.

7. The method according to claim 6, wherein the inclination coefficient Kₓ in the X direction, the inclination coefficient K_{y} in the Y direction, and the ideal load value Wtᵢ of the load cell are obtained by solving an equation set, wherein the equation set is denoted as:
$$\{ \begin{matrix}\sum {w}_{i} & = {\sum }_{i = 1}^{N} {Wt}_{i} \\ {C}_{x} & = \frac{{\sum }_{i = 1}^{N} {Wt}_{i} \cdot {x}_{i}}{{\sum }_{i = 1}^{N} {Wt}_{i}} \\ {C}_{y} & = \frac{{\sum }_{i = 1}^{N} {Wt}_{i} \cdot {y}_{i}}{{\sum }_{i = 1}^{N} {Wt}_{i}} \\ {Wt}_{i} & = {Wt}_{1} + {K}_{x} ( {x}_{n} - {x}_{1} ) + {K}_{y} ( {y}_{n} - {y}_{1} )\end{matrix} .$$

8. The method according to claim 1, wherein a load difference between the ideal load value and the actual load value of each of the N load cells is computed by Δwᵢ=Wtᵢ−wᵢ, wherein Δwᵢ indicates the load difference of each the N load cells, Wtᵢ indicates an ideal load value of each of the N load cells, wᵢ indicates an actual load value of each of the N load cells, and i indicates an i^{th} load cell.

9. The method according to claim 1, wherein a gasket is installed for a load cell having a load difference with a lowest value.

10. The method according to claim 1, wherein the N load cells of the weighing system represent at least three load cells.

11. The method according to claim 8, wherein a gasket is installed for a load cell having a load difference with a lowest value.
